(19) United States
(12) Patent Application Publication
(10) Pub. No.: US 2003/0101067 A1
(43) Pub. Date: May 29, 2003

(54) Method of profiling talent in a multimedia format

(76) Inventors: Jose A. Duran, Key Biscayne, FL (US); Sarah A. Duran, Key Biscayne, FL (US); Mack B. Pearsall JR., Key Biscayne, FL (US); Jerome Duran, New York, NY (US)

Correspondence Address: Joseph W. Bain, Esq., Akerman, Senterfitt & Eidson, P.A., Post Office Box 3188, West Palm Beach, FL, 33402-3188, US

(21) Appl. No.: 09/996,482

(22) Filed: Nov. 27, 2001

(51) Int. Cl. G06F 17/60; H04K 1/00; H04L 9/00

(52) U.S. Cl. 705/1

(57) ABSTRACT

A method (100) of profiling a model in a multimedia format includes the step (102) of providing a main page (10) illustrating at least a name (19) with one main picture (20). The method further provides (104) for a main menu including functions selected from the group including an exit (11), a video (12), a portfolio view (13), a 3-Dimensional view (14), an interactive (18), an email (15), a sound on/off (16), or a statistics (17) function. The main page also provides (106) thumbnail pictures (23) of the model, wherein each (24) of the thumbnail pictures have associated full pictures (25 or 31) and wherein cursor placement above a selected thumbnail picture causes (114) the associated full picture to appear as an insert to the main picture.

### BACKGROUND OF THE INVENTION

1. Field of Invention

This invention relates to a method of presenting an individual's talent or an object's characteristics, and more particularly to method of profiling such talent or characteristics in a multimedia format.

2. Description of the Related Art

In the modeling industry, individual models and model agencies spend great effort and expense in preparing the various presentation tools that the models need to convince the advertising world to hire such models. These presentation tools typically include a composite card or “comp card”, a portfolio, and a VHS tape. The comp card is a 5″×7″ card usually including various pictures of the model on one side and measurements of the model on the opposing side and could be equated to a business card that gives the hiring person the initial impression of the model. The portfolio is a binder or book of 8½″×11″ photographs of the model. In some cases, some models have VHS tapes giving exemplary video footage of their abilities on a fashion runway or in commercials. Each of these items may cost several hundreds or thousands of dollars for a model depending on the quality and quantity. In combination, these tools become quite an expense for either an individual model or an agency. Furthermore, the three separate items become quite cumbersome to produce or transport adding further cost. In many instances, these items are required to be mailed back and forth between modeling agencies or individual models and their booking agent or clients, adding further to the cost of doing business. Furthermore the comp card, portfolio, and VHS tape are static in the sense that they cannot be easily manipulated as desired by a hiring agent. In other words, these tools are not interactive in any sense.

Comparable cumbersome “tools” are used in other industries to assess talent before a hiring or recruiting decision is made. Actors and actresses may actually get initially assessed in a similar fashion before they are called in to read a part in person. A football, baseball, basketball, soccer, gymnastics or other type of athletic coach or director at the collegiate, semi-professional or professional level may also use something similar to a comp card that includes statistics about the athlete as well as VHS tapes before deciding to heavily recruit an individual. Advertising products in general in the traditional medium of print or television is static and not interactive and does not allow the consumer or purchaser to manipulate and vary certain factors that may be critical to their purchasing decision. Thus, a need exists for a method of profiling talent or characteristics in a multimedia format that will become a cost effective and less cumbersome replacement to the traditional tools currently being used. A further need exists for a method of profiling talent or characteristics of an object in an interactive fashion.

### BRIEF DESCRIPTION OF THE DRAWINGS

Having briefly described the invention, the same will become better understood from the following detailed discussion, read in conjunction with the drawings wherein:

FIG. 1 is a representation of a main page having a main picture and a plurality of thumbnail pictures in accordance with the present invention.

FIG. 2 is a representation of a main page with a thumbnail picture selected and inserted on the main picture in accordance with the present invention.

FIG. 3 is a representation of a main page with a thumbnail picture selected and replacing the main picture in accordance with the present invention.

FIG. 4 is a representation of a page illustrating a video function in accordance with the present invention.

FIG. 5 is a representation of a page illustrating a portfolio view function in accordance with the present invention.

FIG. 6 is a diagram illustrating the front side of a sample CD jacket serving as a composition card in accordance with the present invention.

FIG. 7 is a diagram illustrating the back side of a sample CD jacket serving as a composition card in accordance with the present invention.

FIG. 8 is a flow chart illustrating a method in accordance with the present invention.

### DETAILED DESCRIPTION OF THE PREFERRED EMBODIMENTS

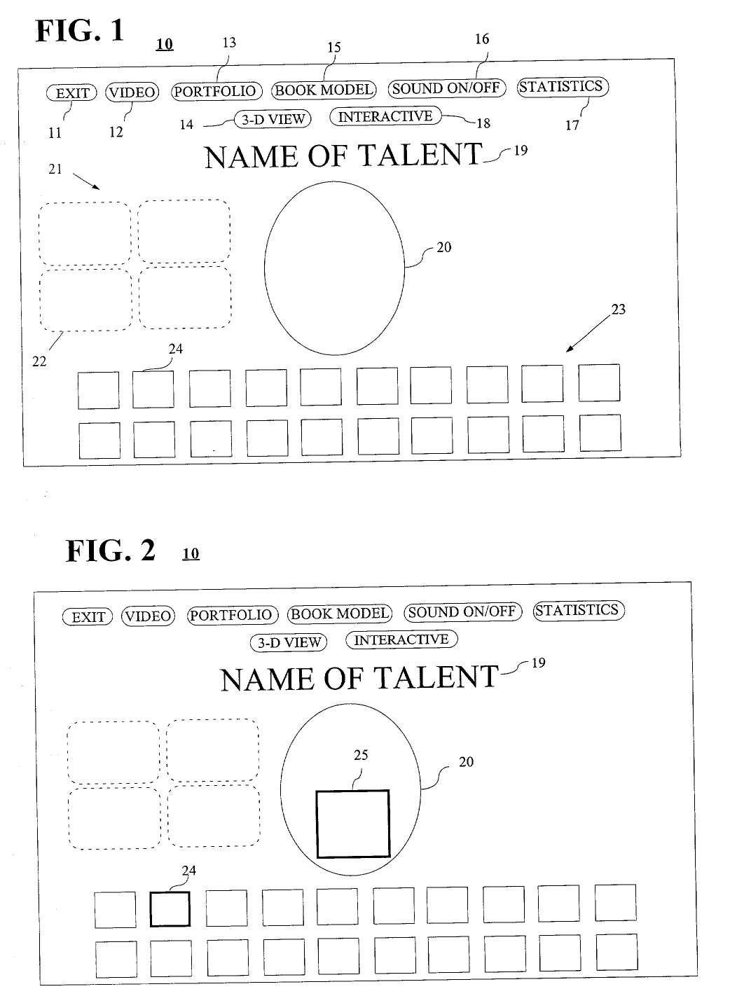

Referring to FIG. 1, there is shown is a representation of a main page 10 having a main picture 20 and a plurality of thumbnail pictures 23 in accordance with the present invention. This main page and the other pages described in FIGS. 2-7 also illustrate a method of profiling a talent or object in a multimedia format that can be stored in a storage medium such as a CD-ROM, CD-R, CD-RW, DVD-ROM, DVD-R, DVD-RW, DAT, a hard drive, or other storage medium that can be accessed independently or remotely through a network via a website for example. The main page 10 also preferably comprises at least a name 19 for the talent, a portfolio view function 13, and a book talent function 15 which essentially can be a direct email link to the booking agent representing the talent or a sales representative for a product being profiled. Optionally, the main page 10 can also include an exit function 11, a video function 12, a 3-dimensional view function 14, an interactive function 18, a sound on/off function 16, or a statistics function 17. The main page 20 may also comprise a plurality of thumbnail videos 21.

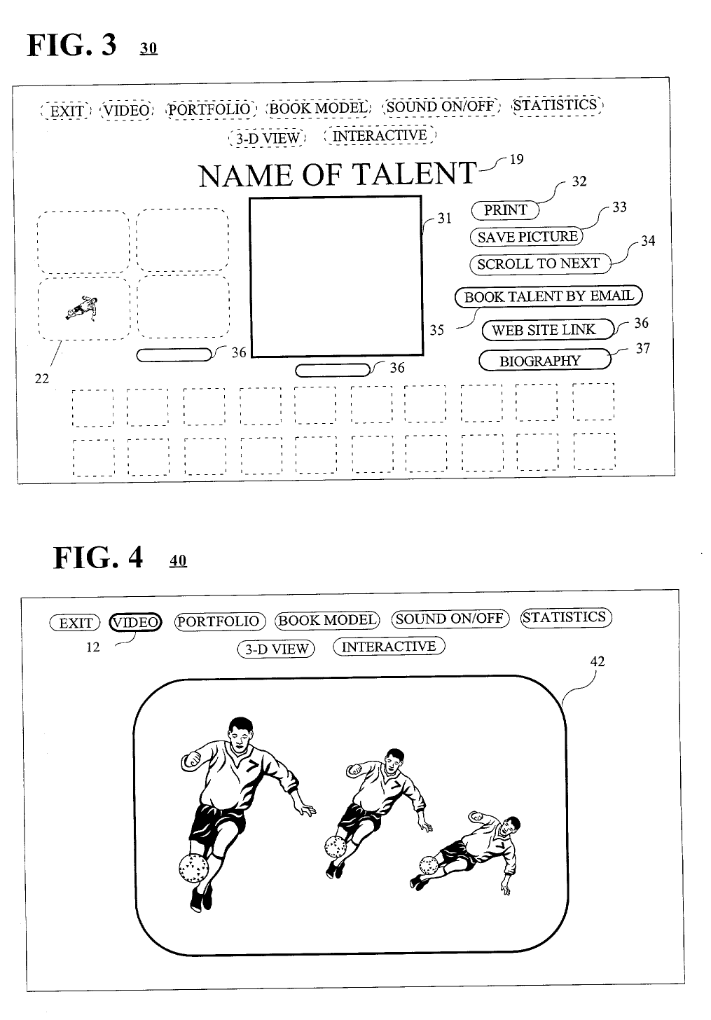

Referring now to FIGS. 1,2 and 3, when one of the plurality of thumbnail pictures 23 is selected (such as picture 24), an associated full picture 25 can be illustrated as an insert to the main picture 20 as shown in FIG. 2. Alternatively, when the picture 24 is selected, it can replace the main picture 20 as an associated full picture 31 as shown in FIG. 3. Preferably, Macromedia Flash software is used so that as the cursor rests over a particular thumbnail picture, the associated full picture pops up as an insert into the main picture 20 as shown in FIG. 2. And, when the user actually selects the picture by clicking or doubling clicking on it, the associated full picture replaces the main picture as shown in FIG. 3. It should be understood that “replacing” does not mean replacement of the picture in the same 2-dimensional space where the main picture 20 was situated, but can mean a simple substitution that constitutes either more or less than the original two-dimensional area previously held by the main picture 20. In response to the selection of one of the thumbnail pictures, another screen 30 can have further functions such as a print function 32, a save picture function 33, a scroll to next picture function 34, a book talent by email function 35. A website link 36 could also be provided to facilitate network communication to various entities associated with the talent being profiled. For example, links or hyperlinks can be provided to the talent agency such as the Elite Modeling Agency sponsoring the talent such as a model. Links can also be provided to former or existing clients of the talent associated with either the pictures or videos highlighted on the main screen or other screens. For example, if a model provided pictures, commercial clips or videos from Victoria's Secret, Guess, Armani or another advertiser, then links could be provided to such advertisers, preferably in the vicinity of the associated picture or video. As with the website link function 36, a biography function 37 could also be provided for the associated talent agency or former or existing clients highlighted in the pictures or videos. Additionally, the biography function 37 may also be provided giving a written description of the talent. This is particularly useful when a booking agent is seeking talent of a certain background that might not necessarily be highlighted through the “statistics” function. As an alternative, the written biographical information for the talent could appear on-screen by either clicking on the name 19 or placing the cursor over the name 19.

As with main page 20, screen 30 can also include a plurality of thumbnail videos 21. If one of the thumbnail videos is selected such as thumbnail video 22, then an associated full video 42 can be shown on screen 40 as illustrated in FIG. 4. The full video can be initiated in many different ways contemplated within the claims of the present invention including the ways previously described with respect to the thumbnail pictures. It should be understood that the full video could run on the entire screen or on a portion of the screen as shown. It should also be understood that the video could run in a variety of formats including, but not limited to MPEG or Quicktime formats.

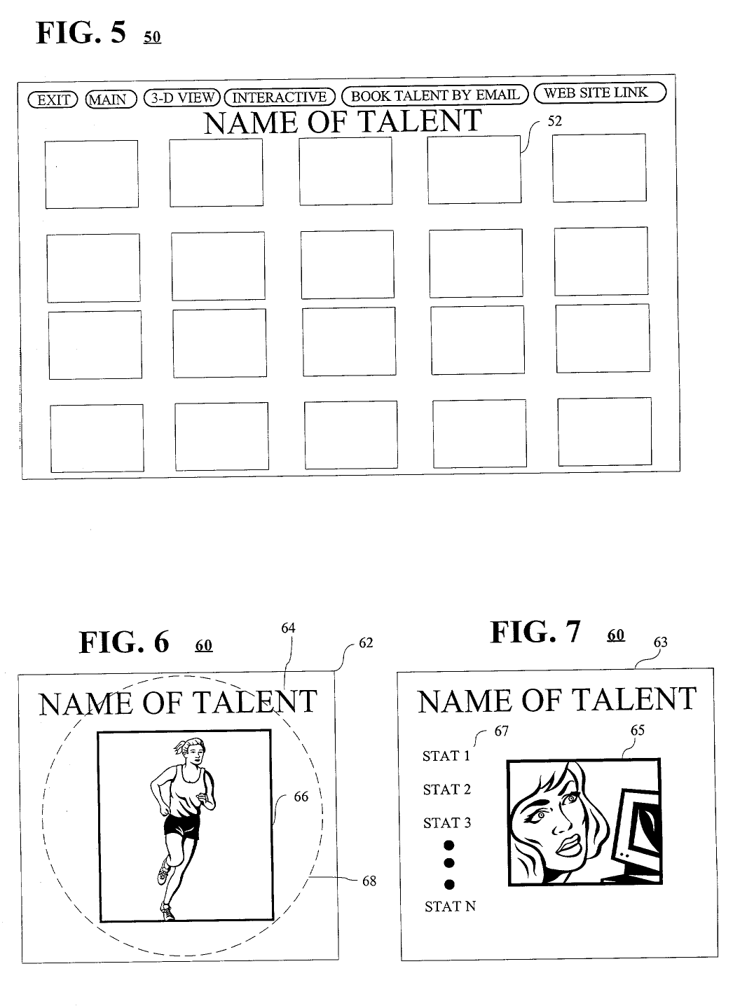

Referring to screen 50 of FIG. 5, the selection of the portfolio view function causes all the associated full pictures 52 for each of the plurality (23) of thumbnail pictures to be illustrated on a single screen. It should be understood that the present invention is not limited to a single talent target on a single screen, but multiple talents or objects can be profiled on a screen. For instance, several models from a single modeling agency or several players from a basketball team can be profiled in the manner described above. For example, 4 separate models can each have their own separate video and have 5 thumbnails pictures each illustrating or profiling their talent. Of course, other arrangements and configurations can be made within contemplation of the present invention. Although the present description may be directed to models or athletes, it should be understood that the present invention could equally apply with actors, actresses, dancers, singers, musicians, sculpture artists, painters, clowns, comedians, animals, physicians, attorneys, accountants, salesmen, corporations, cartoon characters, robotic devices, automobiles, boats, airplanes or other individuals or products.

To simulate a composition card as is customarily used in the modeling industry, the present invention may also include a statistics or measurement function. Depending on the talent being profiled, these statistics and measurement may vary widely, but such exemplary statistics can include height, weight, chest size, waist size, hip size, hair color, eye color, skin color, age, national origin, run time at a given distance, height able to vertically jump, hang time, voice register, voice range, speed, horsepower, billing rate, years of experience, or any combination thereof. Another aspect of the present invention that simulates the composition card is illustrated in FIGS. 6 and 7 where the front (62) and back (62) of a CD jacket 60 are illustrated. Preferably on the front 62 of the CD jacket 60, the name 64 of the talent being profiled is shown as well as a full picture 66 of the talent. The picture 66 is preferably one of the associated full pictures (such as picture 52 of FIG. 5) that are electronically stored on the CD 68. On the reverse or back 63 of the CD jacket 60, another full picture 65 for the talent and corresponding statistics 67 can be illustrated. The CD jacket 60 thus serves as a preliminary tactile tool for a booking agent or other decision maker in their attempts to make a decision whether to sign on the talent or in their decision how to use the talent in their project.

The present invention may also include a number of other functions such as an interactive function or a 3-D function. The interactive function in a model profiling environment could allow a user to manipulate the model in one or more ways selected from the group of manipulating dimensions of the model, changing articles of clothing on the model, changing hair color, changing eye color or changing the voice for example. Thus, a decision maker for a advertising agency for example can try different clothing on the model or change her hair or eye color before making their decision to hire the model.

In yet another aspect of the present invention, a multimedia business card profiling the talent of an individual preferably comprises a storage medium and a computer program and associated data files stored on the storage medium enabling the display on a video monitor of a main page illustrating a name of the individual along with at least one main picture representative of the individual, wherein the main page further comprises a menu of functions comprising a communication function and a portfolio view function and other functions selected from the group comprising an exit function, a video function, an email function, a sound on/off function, a 3-Dimensional view function, an interactive function, or a measurements function. The business card may also include a plurality of thumbnail pictures on the main page, wherein each of the plurality of thumbnail pictures have associated full pictures that appear responsive to the selection of at least one or more of a selected one of the plurality of thumbnail pictures.

In yet another aspect of the present invention, a method of electronically reviewing and booking a talent target can comprise the steps of providing a multimedia presentation of the talent target on a computer terminal coupled to a computer network. The multimedia presentation preferably provides for options selected among the functions of viewing at least one among a plurality of pictures of the talent target, viewing at least one among a plurality of videos of the talent target, viewing all of the plurality of pictures of the talent target on a single video screen, viewing all of the plurality of videos of the talent target, or viewing statistics on the talent target. The method also preferably provides a booking mechanism enabling the electronic booking of the talent target over the computer network. The booking mechanism can be an electronic mail system or a wireless electronic mail system for example.

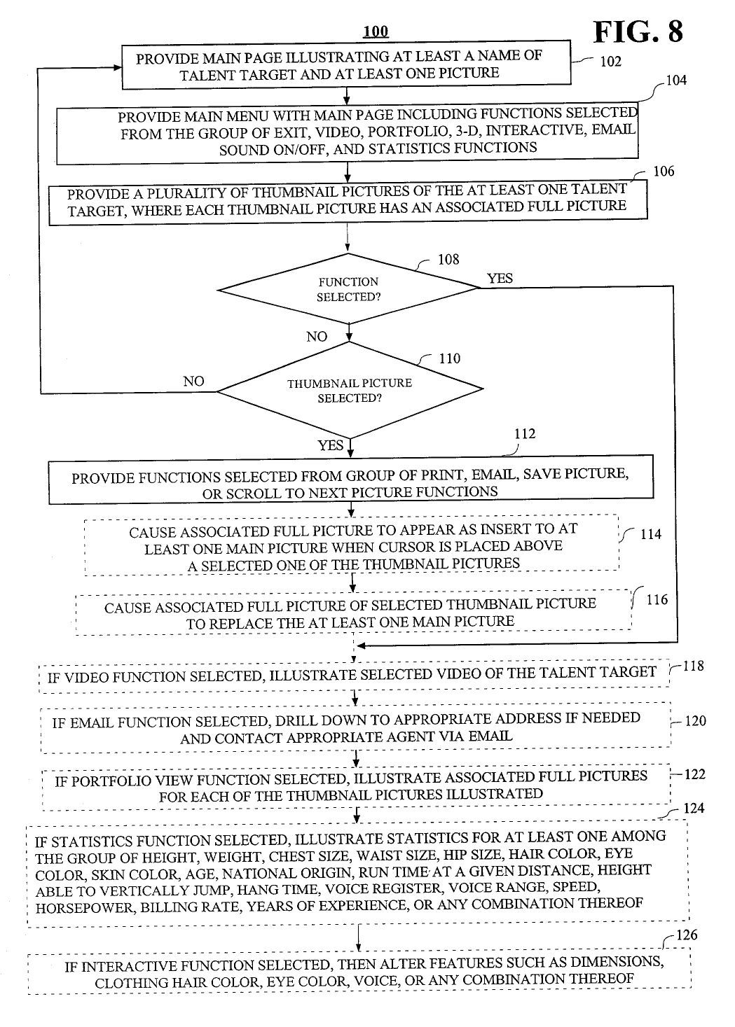

Referring to FIG. 8, a flow chart illustrating a method 100 of profiling talent in a multimedia format on to a storage medium is shown. The method 100 preferably comprises the step 102 of providing a main page illustrating at least a name with at least one talent target and at least one main picture and the step 104 of providing a main menu within the main page including functions selected from the group comprising an exit function, a video function, a portfolio view function, a 3-dimensional view function, an interactive function, an email function, a sound on/off function, or a statistics function. At step 106, a plurality of thumbnail pictures of the at least one talent target on the main page is provided, wherein each of the plurality of thumbnail pictures have associated full pictures. At decision block 108, if a function is selected, then the method will perform the selected functions as described in steps 118, 120, 122, 124, or 126. If no function is selected at decision block 108, then it is determined if a thumbnail picture is selected at decision block 110. If a thumbnail picture is selected, then functions selected from the group comprising a print function, an email function, a save picture function, or a scroll to next picture function are provided at step 112. If a print or save function is selected, then the picture associated with the selected thumbnail picture is preferably printed or saved in the form resembling or substantially resembling a composition card showing the associated picture along with associated statistics or measurements. Optionally, the selection of a thumbnail picture causes the associated full picture to appear as an insert to the at least one main picture when a cursor is placed above a selected one of the plurality of thumbnail pictures at step 114 or alternatively causes the associated picture to replace or substitute for the at least one main picture at step 116. If a video function is selected at decision block 108, then a selected video of the talent target is shown at step 118. If an email function is selected, then an email window is provided to contact an appropriate agent for example for the talent target at step 120. The email function could also provide the ability to attach or insert (either automatically or selectively) a file or a picture resembling the comp card as explained above with regard to the print or save functions. This “virtual comp card” would then be ready to email to the intended recipient or to transfer onto another storage medium as needed. If the talent target can be reached at multiple locations, then it may be necessary to perform a drill-down function to locate the appropriate email location. If a portfolio view function is selected at step 122, then the associated full pictures for each of the plurality of thumbnail pictures are all illustrated on a single screen. If a statistics function is selected at step 124, then statistics selected among the group of height, weight, chest size, waist size, hip size, hair color, eye color, skin color, age, national origin, run time at a given distance, height able to vertically jump, hang time, voice register, voice range, speed, horsepower, billing rate, years of experience, or any combination thereof can be illustrated. If the interactive function or a 3D function is selected at step 126, then the user can have the ability to alter features such as dimensions, clothing, hair color, eye color, voice, or any combination thereof for example.

Although the present invention has been described in conjunction with the embodiments disclosed herein, it should be understood that the foregoing description is intended to illustrate and not limit the scope of the invention as defined by the claims.

What is claimed is:

1. A method of profiling talent in a multimedia format on to a storage medium, comprising the steps of:
providing a main page illustrating at least a name with at least one talent target and at least one main picture;
providing a main menu with the main page including functions selected from the group comprising an exit function, a video function, a portfolio view function, a 3-dimensional view function, an interactive function, an email function, a sound on/off function, or a statistics function;
providing a plurality of thumbnail pictures of the at least one talent target on the main page, wherein each of the plurality of thumbnail pictures have associated full pictures; and
responsive to the selection of one of the plurality of thumbnail pictures, then providing functions selected from the group comprising a print function, an email function, a save picture function, a biography function, or a scroll to next picture function.

2. The method of claim 1, wherein the step of providing the plurality of thumbnail pictures further comprises causing the associated full picture to appear as an insert to the at least one main picture when a curser is placed above a selected one of the plurality of thumbnail pictures.

3. The method of claim 1, wherein clicking above or on the selected one of the plurality of thumbnail pictures causes the associated picture to replace the at least one main picture.

4. The method of claim 1, wherein the selection of the video function illustrates a plurality of thumbnail stills or thumbnail video from each of a plurality of videos for the at least one talent and wherein selection of one of the plurality of thumbnail stills or thumbnail video causes the video to run.

5. The method of claim 4, wherein the selection of one of the plurality of the thumbnail stills or the thumbnail videos is achieved by clicking on or above the selection causing the video to run on a substantial portion of the display.

6. The method of claim 1, wherein the function of emailing enables the ability to book the at least one talent target.

7. The method of claim 1, wherein the talent target is selected from the group comprising a model, actor, actress, dancer, singer, musician, athlete, body builder, sculpture artist, painter, clown, comedian, animal, physician, attorney, accountant, salesman, corporation, cartoon character, robotic device, automobile, boat, airplane or other individual or product.

8. The method of claim 1, wherein the portfolio view function illustrates associated full pictures for each of the plurality of thumbnail pictures on a single screen.

9. The method of claim 1, wherein the statistics functions provides the statistics selected among the group of height, weight, chest size, waist size, hip size, hair color, eye color, skin color, age, national origin, run time at a given distance, height able to vertically jump, hang time, voice register, voice range, speed, horsepower, billing rate, years of experience, or any combination thereof.

10. The method of claim 1, wherein the storage medium is selected from the group comprising a CD-ROM, CD-R, CD-RW, DVD-ROM, DVD-R, DVD-RW, DAT, hard drive, or remote storage accessible via a network.

11. A method of profiling a model in a multimedia format on to a storage medium, comprising the steps of:
providing a main page illustrating at least a name with at least one model and at least one main picture;
providing a main menu with the main page including functions selected from the group comprising an exit function, a video function, a portfolio view function, a 3-Dimensional view function, an interactive function, an email function, a sound on/off function, or a measurements function;
providing a plurality of thumbnail pictures of the at least one model on the main page, wherein each of the plurality of thumbnail pictures have associated full pictures and wherein curser placement above a selected one of the plurality of thumbnail pictures causes the associated picture to the selected one to appear as an insert to the at least one main picture; and
if one of the plurality of thumbnail picture is selected, then providing functions selected from the group comprising a print function, an email function, a save picture function, a biography function, or a scroll to next picture function.

12. The method of claim 11, wherein the storage medium is a CD-Rom having a jacket cover illustrating the at least one main picture or at least one associated full picture corresponding to at least one of the plurality of thumbnail pictures.

13. The method of claim 11, wherein the interactive functions allows a user to manipulate the model in one or more ways selected from the group of manipulating dimensions of the model, changing articles of clothing on the model, changing hair color, changing eye color or changing the voice.

14. A multimedia business card profiling the talent of an individual, comprising:
a storage medium;
a computer program and associated data files stored on the storage medium enabling the display on a video monitor of a main page illustrating a name of the individual along with at least one main picture representative of the individual, wherein the main page further comprises a menu of functions comprising a communication function and a portfolio view function and other functions selected from the group comprising an exit function, a video function, an email function, a sound on/off function, a 3-Dimensional view function, an interactive function, or a measurements function; and
a plurality of thumbnail pictures on the main page, wherein each of the plurality of thumbnail pictures have associated full pictures that appear responsive to the selection of at least one or more of a selected one of the plurality of thumbnail pictures.

15. The multimedia business card of claim 14, wherein curser placement above a selected one of the plurality of thumbnail pictures causes the associated picture to the selected one to appear as an insert to the at least one main picture and wherein if one of the plurality of thumbnail pictures is selected, then providing functions selected from the group comprising a print function, an email function, a save picture function, or a scroll to next picture function.

16. The multimedia business card of claim 14, wherein the storage medium is selected from the group comprising a CD-ROM, CD-R, CD-RW, DVD-ROM, DVD-R, DVD-RW, DAT, hard drive, or remote storage accessible via a network.

17. The multimedia business card of claim 16, wherein the CD-ROM is stored in a jacket or jewel case illustrating the at least one main picture or at least one associated full picture corresponding to the at least one of the plurality of thumbnail pictures.

18. A method of electronically reviewing and booking a talent target, comprising the steps of:
providing a multimedia presentation of the talent target on a computer terminal coupled to a computer network, the multimedia presentation having options selected among the functions of viewing at least one among a plurality of pictures of the talent target, viewing at least one among a plurality of videos of the talent target, viewing all of the plurality of pictures of the talent target on a single video screen, viewing all of the plurality of videos of the talent target, or viewing statistics on the talent target; and
providing a booking mechanism enabling the electronic booking of the talent target over the computer network.

19. The method of claim 18, wherein the booking mechanism is an electronic mail system.

20. The method of claim 18, wherein the booking mechanism is a wireless electronic mail system.
